(19) United States
(12) Patent Application Publication
(10) Pub. No.: US 2022/0180267 A1
(43) Pub. Date: Jun. 9, 2022

(54) INFORMATION PROCESSING APPARATUS, REQUEST MANAGEMENT METHOD, AND RECORDING MEDIUM

(71) Applicant: Shimpei NAKAGAWA, Kanagawa (JP)

(72) Inventor: Shimpei NAKAGAWA, Kanagawa (JP)

(73) Assignee: Ricoh Company, Ltd., Tokyo (JP)

(21) Appl. No.: 17/457,965

(22) Filed: Dec. 7, 2021

(30) Foreign Application Priority Data
Dec. 9, 2020 (JP) 2020-204425

(51) Int. Cl. G06Q 10/06

(52) U.S. Cl. CPC G06Q 10/06311

(57) ABSTRACT

An information processing apparatus includes circuitry; and a memory storing computer-executable instructions that cause the circuitry to execute transmitting, to a terminal operated by a worker, completion report information used for reporting completion of work that is requested, in association with work request information relating to a request for the work; and updating a value of a progress status of the work identified by the completion report information, in request management data by which the progress status is managed, to a value indicating completion of the work, in response to receiving the completion report information from the terminal.

### CROSS-REFERENCE TO RELATED APPLICATION

The present application is based on and claims priority under 35 U.S.C. § 119 to Japanese Patent Application No. 2020-204425, filed on Dec. 9, 2020, the contents of which are incorporated herein by reference in their entirety.

### BACKGROUND OF THE INVENTION

### 1. Field of the Invention

The present invention relates to an information processing apparatus, a request management method, and a recording medium.

### 2. Description of the Related Art

Techniques have been developed to manage the progress status of requested work. For example, a task management system is disclosed, in which a reminder is reported to the worker at the request destination according to need.

Patent Document 1: Japanese Unexamined Patent Application Publication No. 2014-127171

### SUMMARY OF THE INVENTION

According to one aspect of the present invention, there is provided an information processing apparatus including circuitry; and a memory storing computer-executable instructions that cause the circuitry to execute transmitting, to a terminal operated by a worker, completion report information used for reporting completion of work that is requested, in association with work request information relating to a request for the work; and updating a value of a progress status of the work identified by the completion report information, in request management data by which the progress status is managed, to a value indicating completion of the work, in response to receiving the completion report information from the terminal.

### BRIEF DESCRIPTION OF THE DRAWINGS

FIG. 1 is a diagram illustrating an example of a system configuration of a request management system according to a first embodiment of the present invention;

FIG. 2 is a diagram illustrating an example of a hardware configuration of a request management server according to the first embodiment of the present invention;

FIG. 3 is a diagram illustrating an example of a hardware configuration of a terminal according to the first embodiment of the present invention;

FIG. 4 is a diagram illustrating an example of functions of a request management server according to the first embodiment of the present invention;

FIG. 5 is a diagram illustrating an example of functions of a terminal according to the first embodiment of the present invention;

FIG. 6 is a diagram illustrating an example of user data according to the first embodiment of the present invention;

FIG. 7 is a diagram illustrating an example of request management data according to the first embodiment of the present invention;

FIG. 8 is a diagram illustrating an example of a sequence of a work request process according to the first embodiment of the present invention;

FIG. 9 is a diagram illustrating an example of a work request input screen according to the first embodiment of the present invention;

FIG. 10 is a diagram illustrating an example of a work request report mail according to the first embodiment of the present invention;

FIG. 11 is a diagram illustrating an example of a work result confirmation screen according to the first embodiment of the present invention;

FIG. 12 is a diagram illustrating an example of a system configuration of a request management system according to a second embodiment of the present invention;

FIG. 13 is a diagram illustrating an example of a sequence of a work request process according to the second embodiment of the present invention;

FIG. 14 is a diagram illustrating an example of a schedule display screen according to the second embodiment of the present invention;

FIG. 15 is a diagram illustrating an example of a work request input screen according to a third embodiment of the present invention;

FIG. 16 is a diagram illustrating an example of request management data according to the third embodiment of the present invention;

FIG. 17 is a diagram illustrating an example of a sequence of a work request process according to the third embodiment of the present invention;

FIG. 18 is a diagram illustrating an example of a work request report mail according to the third embodiment of the present invention; and

FIG. 19 is a diagram illustrating an example of a work detail screen according to the third embodiment of the present invention.

### DESCRIPTION OF THE EMBODIMENTS

If the requested work is not directed to the requester, the requester cannot directly identify the progress status of the work. Therefore, the worker has to report the completion of the work to the requester when the requested work is completed. However, conventionally, the procedures for reporting the completion of the work have been cumbersome. If the procedures of reporting the completion are cumbersome, this may cause the worker to forget to report the completion, and the requester may be unable to accurately identify the progress status of the work.

A problem to be addressed by an embodiment of the present invention is to facilitate the reporting of the completion of work by a worker.

### (First Embodiment)

Hereinafter, embodiments of a request management system according to an embodiment of the present invention will be described with reference to the drawings.

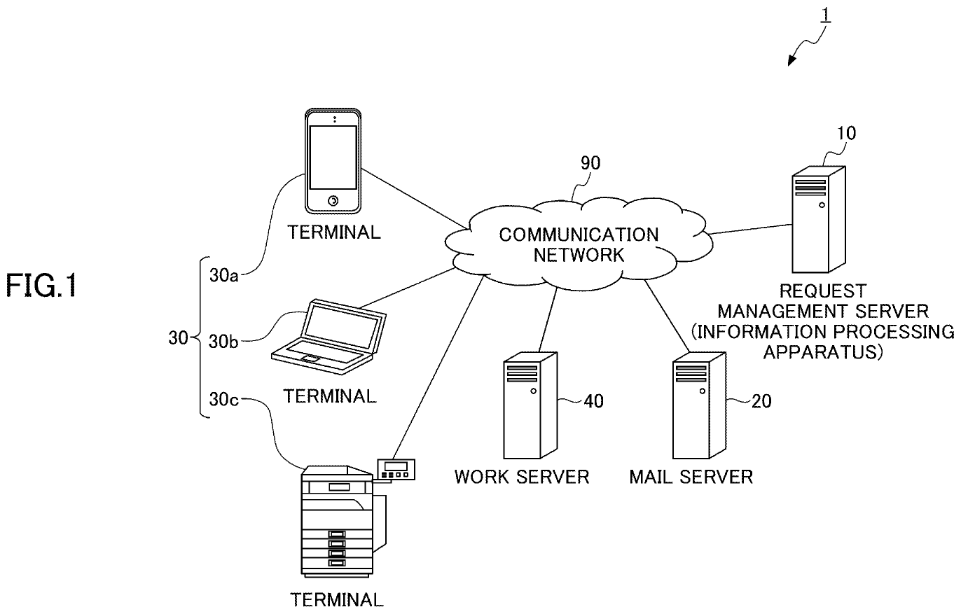

FIG. 1 is a diagram illustrating an example of a system configuration of a request management system according to the first embodiment.

A request management system 1 includes a request management server 10 (an example of an information processing apparatus), a mail server 20, a terminal 30 (a terminal 30a, a terminal 30b, a terminal 30c, and the like), and a work server 40. The request management server 10, the mail server 20, the terminal 30, and the work server 40 are communicatively connected via a communication network 90.

The request management server 10 is an information processing apparatus that manages the progress status of the requested work by using request management data. For example, the request management server 10 receives the work request information from the terminal 30 operated by the requester and stores the work request information as request management data, and transmits a work request report mail addressed to the e-mail address of the worker, to the mail server 20. The request management server 10 receives completion report information from the terminal 30 operated by the worker and updates a value indicating the progress status, in the request management data.

The mail server 20 is a server apparatus including an e-mail transmitting and receiving function. For example, the mail server 20 receives a work request report mail from the request management server 10 and transmits the work request report mail to the terminal 30 operated by the worker.

The terminal 30 is a terminal apparatus for using the functions provided by the request management server 10, the mail server 20, or the work server 40 in response to an operation by a user who is a requester or a worker. The terminal 30 is a generic term that does not distinguish individual terminals such as the terminal 30a, the terminal 30b, the terminal 30c, and the like. The user using the terminal 30 may be a requester requesting the work or may become a worker upon receiving a request for work.

That is, each user may be a requester for certain work and a worker for other work.

The work server 40 is a server apparatus used by a user who is the worker for performing the work. For example, when the work content is to input attendance, the work server 40 is an apparatus that provides an attendance management function.

The communication network 90 is a communication network according to wireless or wired communication. The communication network 90 may be, specifically, the Internet, a Wide Area Network (WAN), a Local Area Network (LAN), a Virtual Private Network (VPN), a combination thereof, or the like.

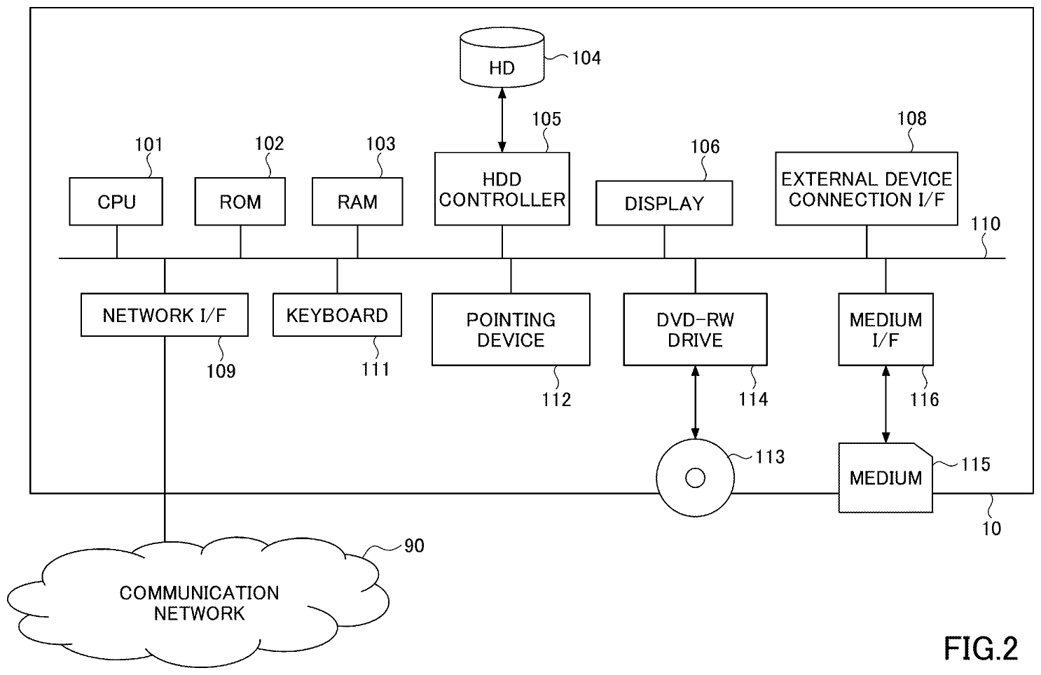

FIG. 2 is a diagram illustrating an example of a hardware configuration of the request management server.

As illustrated in FIG. 2, the request management server 10 is configured by a computer and includes a central processing unit (CPU) 101, a read-only memory (ROM) 102, a random access memory (RAM) 103, a hard drive (HD) 104, a hard disk drive (HDD) controller 105, a display 106, an external device connection interface (I/F) 108, a network I/F 109, a data bus 110, a keyboard 111, a pointing device 112, a Digital Versatile Disc Rewritable (DVD-RW) drive 114, and a medium I/F 116.

Among these, the CPU 101 controls the operation of the entire request management server 10. The ROM 102 stores a program used to drive the CPU 101, such as an Initial Program Loader (IPL). The RAM 103 is used as a work area of the CPU 101. The HD 104 stores various kinds of data such as a program. The HDD controller 105 controls the reading or writing of various data from or to the HD 104 according to the control of the CPU 101. The display 106 displays various kinds of information such as cursors, menus, windows, characters, or images.

The external device connection I/F 108 is an interface for connecting various external devices. In this case, the external device is, for example, a device such as a Universal Serial Bus (USB) memory, a printer, or the like. The network I/F 109 is an interface for performing data communication with the mail server 20 or the terminal 30 via the communication network 90. The data bus 110 is an address bus or data bus for electrically connecting elements such as the CPU 101 illustrated in FIG. 2.

The keyboard 111 is a type of input means including a plurality of keys for inputting items such as characters, numbers, various instructions, and the like. The pointing device 112 is a type of input means for selecting or executing various instructions, selecting a processing target, moving a cursor, and the like. The DVD-RW drive 114 controls the reading or writing of various kinds of data from or to the DVD-RW 113 that is an example of a removable recording medium. The recording medium may not only be a DVD-RW but also a Digital Versatile Disc Recordable (DVD-R) or the like. The medium I/F 116 controls the reading or writing (storage) of data from or to a medium 115, such as a flash memory.

The mail server 20 and the work server 40 have the same hardware configuration as the request management server 10.

The terminal 30 may have a hardware configuration similar to the request management server 10, and may be a device such as a smartphone, a wearable personal computer (PC), a desktop PC, or the like. The terminal 30 may be a Multifunction Peripheral (MFP), an Interactive White Board (IWB, a whiteboard having an electronic blackboard function capable of mutual communication), a projector (PJ), a digital signage, or the like, as long as the browser function can be used.

As an example, a hardware configuration where the terminal 30 is a smartphone is illustrated.

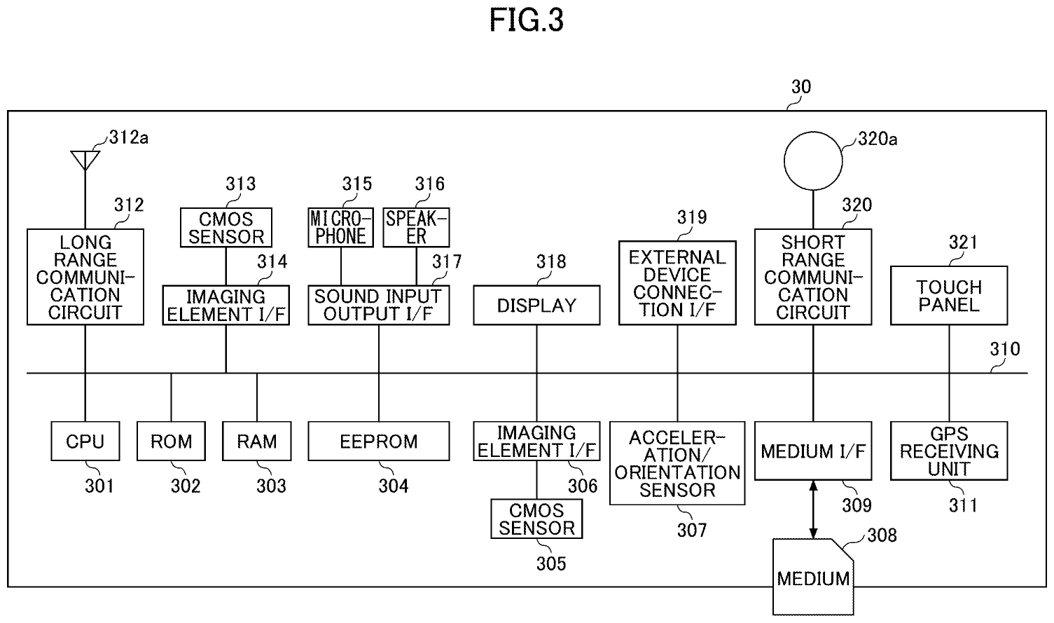

FIG. 3 is a diagram illustrating an example of a hardware configuration of a terminal.

The terminal 30 includes a CPU 301, a ROM 302, a RAM 303, an Electrically Erasable Programmable

Read-Only Memory (EEPROM) 304, a Complementary Metal-Oxide-Semiconductor (CMOS) sensor 305, an imaging element I/F 306, an acceleration/orientation sensor 307, a medium I/F 309, and a global positioning system (GPS) receiving unit 311.

Among these, the CPU 301 controls the operation of the entire terminal 30. The ROM 302 stores the CPU 301 or a program used to drive the CPU 301 such as an IPL. The RAM 303 is used as the work area of the CPU 301. The EEPROM 304 reads or writes various kinds of data such as a smartphone program according to the control of the CPU 301. The CMOS sensor 305 is a type of built-in imaging means that captures a subject (mainly a self-image) according to the control of the CPU 301 and obtains image data.

The imaging means may be, for example, a Charge Coupled Device (CCD) sensor, instead of a CMOS sensor.

The imaging element I/F 306 is a circuit that controls the driving of the CMOS sensor 305. The acceleration/orientation sensor 307 includes a variety of sensors, such as an electromagnetic compass for detecting geomagnetic fields, a gyrocompass, an acceleration sensor, or the like. The medium I/F 309 controls the reading or writing (storage) of data from or to a recording medium 308, such as a flash memory. The GPS receiving unit 311 receives the GPS signal from the GPS satellite.

The terminal 30 further includes a long range communication circuit 312, an antenna 312a of the long range communication circuit 312, a CMOS sensor 313, an imaging element I/F 314, a microphone 315, a speaker 316, a sound input/output I/F 317, a display 318, an external device connection I/F 319, a short range communication circuit 320, an antenna 320a of the short range communication circuit 320, and a touch panel 321.

Among these, the long range communication circuit 312 is a circuit for communicating with the request management server 10, the mail server 20, or the work server 40 via the communication network 90 (wireless network). The CMOS sensor 313 is a type of built-in imaging means that captures a subject according to the control of the CPU 301 and obtains image data. The imaging element I/F 314 is a circuit that controls the driving of the CMOS sensor 313. The microphone 315 is a built-in circuit that converts sound to an electrical signal. The speaker 316 is a built-in circuit that converts electrical signals to physical vibrations to produce sound, such as music and voice sound.

The sound input/output I/F 317 is a circuit that processes the input and output of sound signals between the microphone 315 and the speaker 316 according to the control of the CPU 301. The display 318 is a type of display means such as a liquid crystal display or an organic Electro Luminescent (EL) display for displaying an image of a subject or various icons. The external device connection I/F 319 is an interface for connecting various external devices. The short range communication circuit 320 is a communication circuit such as a Near Field Communication (NFC) or Bluetooth (registered trademark). The touch panel 321 is a type of input means used for operating the terminal 30 by the user by pressing the display 318.

The terminal 30 also includes a bus line 310. The bus line 310 is an address bus or data bus or the like for electrically connecting elements such as the CPU 301 illustrated in FIG. 3.

Next, the functions of each apparatus will be described with reference to the drawings.

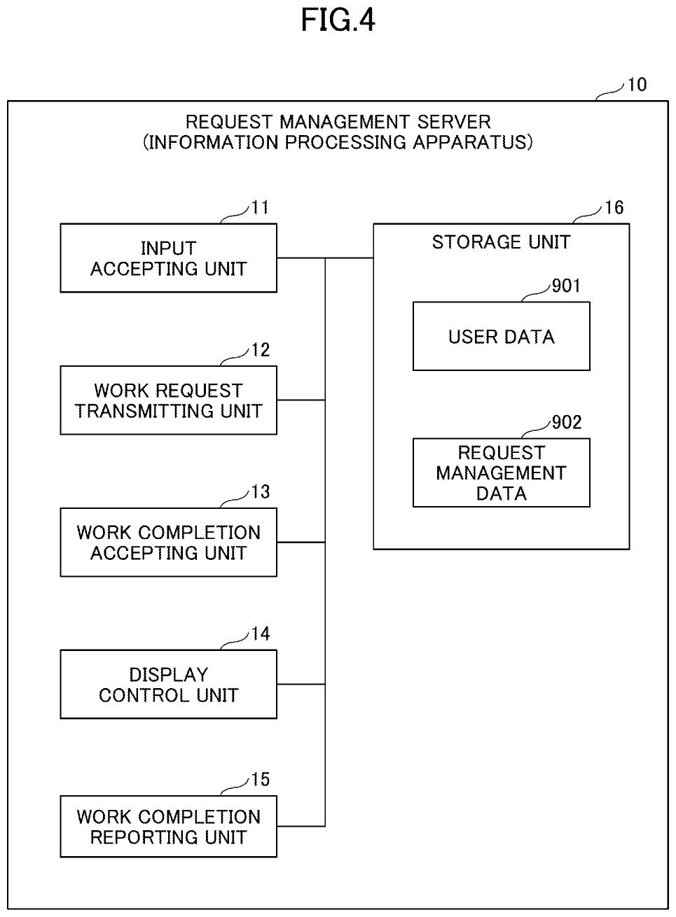

FIG. 4 is a diagram illustrating an example of a function of a request management server.

The request management server 10 includes an input accepting unit 11, a work request transmitting unit 12, a work completion accepting unit 13, a display control unit 14, a work completion reporting unit 15, and a storage unit 16.

The input accepting unit 11 accepts input of information from the terminal 30 by the operation by the user. For example, the input accepting unit 11 accepts information indicating a request for work from the terminal 30 operated by the user who is the requester.

The work request transmitting unit 12 transmits, to the terminal 30 operated by the worker as the destination, completion report information, used for reporting the work completion, in association with work request information relating to the request for the work. Specifically, the work request transmitting unit 12 transmits an e-mail including the work request information and the completion report information to the e-mail address of the worker based on the request management data 902 stored in the storage unit 16. The completion report information is, for example, a Uniform Resource Identifier (URI) that includes an identifier for identifying a worker (a user ID of the worker, etc.) and an identifier for identifying a work request (a work request ID to be described later).

The work completion accepting unit 13 accepts a work completion report. Specifically, when the work completion accepting unit 13 accepts the completion report information from the terminal 30, the work completion accepting unit 13 updates the value of the progress status of the work, identified by the completion report information, in the request management data 902, to a value indicating the work completion. For example, the work completion accepting unit 13 updates the value of the progress status according to communication to the communication destination indicated by the URI that is the completion report information. The format of the communication that the work completion accepting unit 13 accepts may be defined as an Application

Programming Interface (API).

The display control unit 14 controls the display of the terminal 30. Specifically, the display control unit 14 transmits screen data for displaying various kinds of screens described below, to the terminal 30. Specifically, the screen data is transmitted as a Hypertext Transfer Protocol (HTTP) response and is described in a language such as Hypertext Markup Language (HTML).

The work completion reporting unit 15 reports the completion of the work. Specifically, when the work completion accepting unit 13 accepts the completion report information, the work completion reporting unit 15 transmits an e-mail indicating the work completion to the e-mail address of the work requester.

The input accepting unit 11, the work request transmitting unit 12, the work completion accepting unit 13, the display control unit 14, and the work completion reporting unit 15 are implemented by controlling the network I/F 109 or the like by executing the processing defined in a program stored in the ROM 102 or the HD 104, by the CPU 101 by using the RAM 103 or the like as the work area.

The storage unit 16 stores various kinds of data used for various kinds of processing described below. Specifically, the storage unit 16 stores user data 901 and the request management data 902. The details of these pieces of data are described later. The storage unit 16 is implemented by controlling the

ROM 102, the RAM 103, or the HD 104 by performing the processing defined in a program stored in the ROM 102 or the HD 104, by the CPU 101 by using the RAM 103 or the like as the work area.

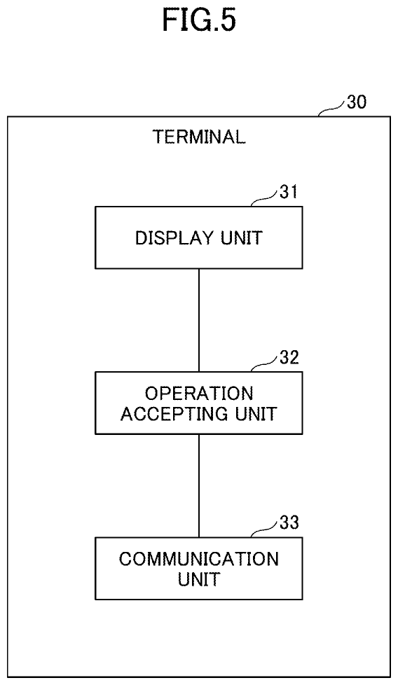

FIG. 5 is a diagram illustrating an example of functions of a terminal.

The terminal 30 includes a display unit 31, an operation accepting unit 32, and a communication unit 33.

The display unit 31 displays various kinds of information such as information received by the communication unit 33. For example, the display unit 31 of the terminal 30 operated by the worker displays the content of the work request report mail together with completion report information and work request information.

The display unit 31 is implemented by controlling the display 318 by performing the processing defined in a program, stored in the ROM 302, the EEPROM 304, or the like, by the CPU 301 by using the RAM 303 or the like as the work area.

The operation accepting unit 32 accepts an operation by a user that is a requester or a worker. For example, the operation accepting unit 32 of the terminal 30 operated by the requester accepts the input operation of the work request information. Further, the operation accepting unit 32 of the terminal 30 operated by the worker accepts, for example, an operation of inputting the attendance, as execution of the work. Further, the operation accepting unit 32 of the terminal 30 operated by the worker accepts an operation of transmitting the completion report information from the worker.

The operation accepting unit 32 is implemented by controlling the touch panel 321 or the like by performing the processing defined in a program, stored in the ROM 302, the EEPROM 304, or the like, by the CPU 301 by using the RAM 303 or the like as the work area.

The communication unit 33 transmits and receives various kinds of information to and from the request management server 10, the mail server 20, or the work server 40. For example, the communication unit 33 of the terminal 30 operated by the requester transmits the work request information input by the requester to the request management server 10. The communication unit 33 of the terminal 30 operated by the worker receives the work request report mail from the mail server 20. The communication unit 33 of the terminal 30 operated by the worker transmits the attendance information input by the worker to the request management server 10.

The communication unit 33 is implemented by controlling the long range communication circuit 312 or the like by performing the processing defined in a program, stored in the ROM 302, the EEPROM 304, or the like, by the CPU 301 by using the RAM 303 or the like as the work area.

Next, various kinds of data stored in the storage unit 16 of the request management server 10 will be described.

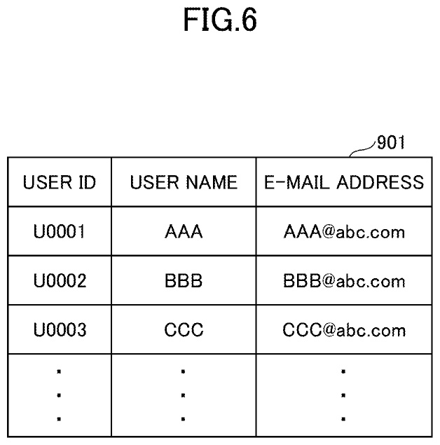

FIG. 6 is a diagram illustrating an example of user data.

The user data 901 is data indicating a user of the work request system. Specifically, the user data 901 includes, as items, a user ID, a user name, and an e-mail address.

The value of the item “user ID” is an identifier to identify the user.

The value of the item “user name” is text indicating the name of the user.

The value of the item “e-mail address” is text indicating the user's e-mail address.

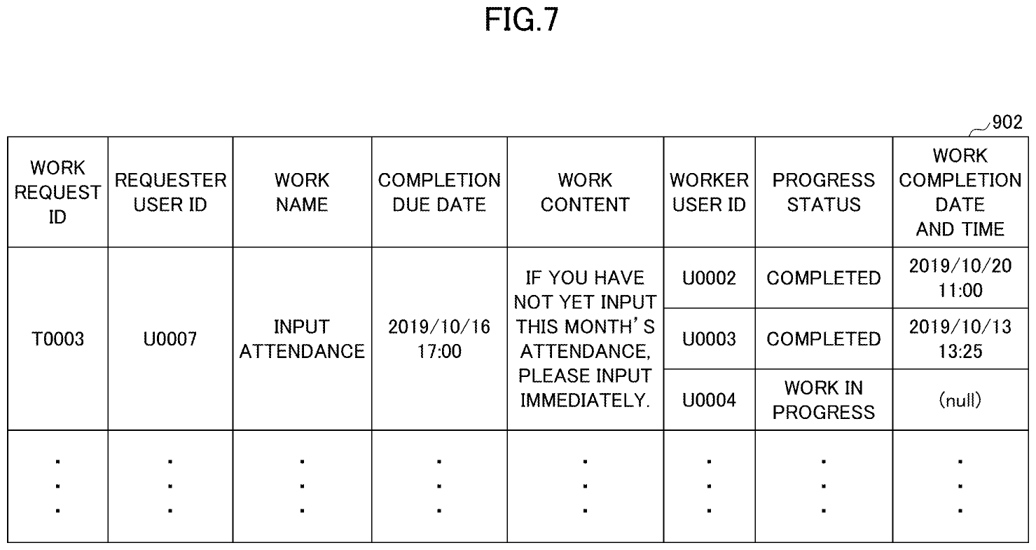

FIG. 7 is a diagram illustrating an example of request management data according to the first embodiment.

The request management data 902 includes, as items, a work request ID, a requester user ID, a work name, a completion due date, a work content, a worker user ID, a progress status, and a work completion date and time.

The value of the item “work request ID” is an identifier for identifying each work request.

The value of the item “requester user ID” is an identifier to identify the requester. The value of the item “requester user ID” is the same as the value of the item “user ID” in the user data 901 indicating the user that is a requester.

The value of the item “work name” is text indicating the name of the work.

The value of the item “completion due date” is the completion due date for the work specified by the requester. Specifically, the value of the item “completion due date” is the year, month, date, hour, and minute.

The value of the item “work content” is text indicating the content of the work input by the requester.

The items “work request ID”, “requester user ID”, “work name”, “completion due date”, and “work content” are items having values for each work request.

The value of the item “worker user ID” is an identifier to identify the worker. The value of the item “worker user ID” is the same as the value of the item “user ID” in the user data 901 indicating the user that is the worker.

The value of the item “progress status” indicates the progress status of the work. For example, when the request management server 10 receives the work request information and transmits the work request report mail, the request management server 10 inserts a data record in which the value of the item “progress status” is “work in progress”. When the request management server 10 receives the completion report information, the request management server 10 updates the value of the item “progress status” to “completed”.

The value of the item “work completion date and time” is a value that indicates the date and time when the work is completed. When the request management server 10 receives the completion report information, the request management server 10 updates the value of the item “work completion date and time” with the date and time when the completion report information is received.

The items “worker user ID”, “progress status”, and “work completion date and time” are items having values for each worker performing the work.

Further, in the request management data 902, the items “work request ID”, “requester user ID”, “work name”, “completion due date”, “work content”, and “worker user ID” are information inserted based on the work request information transmitted from the terminal 30 operated by the requester. The items “progress status” and “work completion date and time” are information that is updated based on the completion report information transmitted from the terminal 30 operated by the worker.

Next, the operation of the request management system 1 will be described with reference to the drawings.

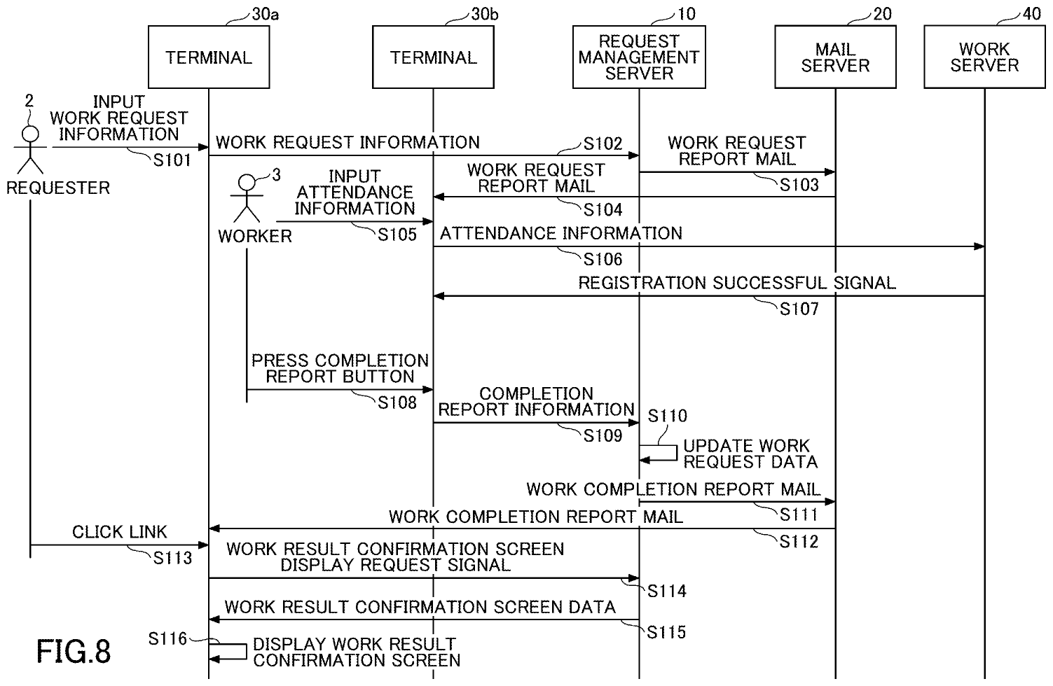

FIG. 8 is a diagram illustrating an example of a sequence of the work request processing according to the first embodiment.

It is assumed that the terminal 30 used by the requester 2 is the terminal 30a, and the terminal 30 used by the worker 3 is the terminal 30b. Further, it is assumed that the data records indicating the requester 2 and the worker 3 are stored in the storage unit 16 as the user data 901.

The requester 2 inputs the work request information to the terminal 30a. Specifically, in step S101, in the work request input screen displayed by the display unit 31 of the terminal 30a, the requester 2 inputs information such as the content of the work to be requested, the worker, the completion due date, and the like.

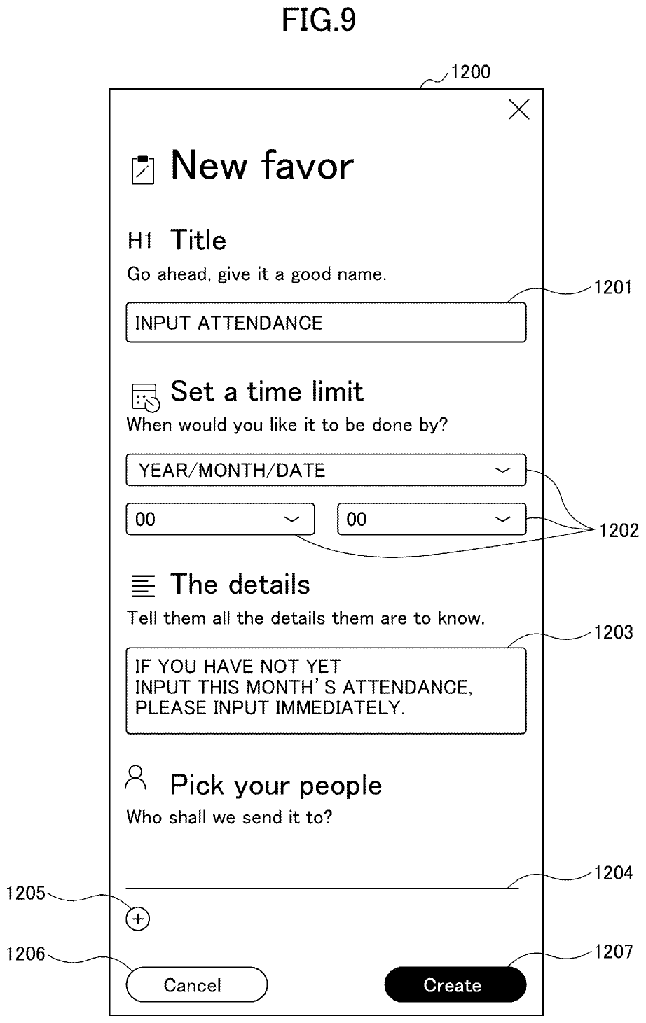

FIG. 9 is a diagram illustrating an example of a work request input screen according to the first embodiment.

A work request input screen 1200 includes a work name input field 1201, a completion due date field 1202, a work content input field 1203, a worker input field 1204, a worker addition button 1205, a cancel button 1206, and a registration button 1207.

The work name input field 1201 is a text box for inputting a work name.

The completion due date field 1202 is a field for inputting the completion due date. The completion due date is input by selecting the year, month, date, hour, and minute, from a pull-down menu. Each option is predefined. For example, the selectable year, month, and date is a date 30 days after the current date, and the selectable hour may be every hour from 0:00 to 23:00, and the selectable minute may be every 10 minutes from 0 minutes to 50 minutes.

The work content input field 1203 is a text area in which a work content is input.

The worker input field 1204 is a text box in which the worker's e-mail address is input. Further, while the requester 2 is inputting the e-mail address, the terminal 30a may display e-mail addresses for complementing the task of inputting of the e-mail address.

Specifically, the terminal 30a executes the processing defined in a script language program embedded in the screen data and transmits, to the request management server 10, a request to extract, from the request management data 902, the e-mail address of the worker to which the requester 2 has previously requested work. When there is an e-mail address among the e-mail addresses received from the request management server 10, including the first character string being input, the terminal 30a displays the corresponding e-mail address for complementing the task of inputting of the e-mail address.

The worker addition button 1205 is a Graphical User Interface (GUI) for adding a worker. When the requester 2 presses the worker addition button 1205, the terminal 30a executes the processing defined in a script language program embedded in the screen data and adds and displays a text box in the worker input field 1204.

The cancel button 1206 is a GUI for canceling the input of a work request.

The registration button 1207 is a GUI for registering the input information.

When the operation accepting unit 32 of the terminal 30a accepts the pressing of the registration button 1207, the communication unit 33 transmits the input information as the work request information to the request management server 10 (FIG. 8, step S102). The input accepting unit 11 of the request management server 10 accepts the work request information.

When the work request information is accepted, the input accepting unit 11 applies the work request information to the request management data 902. Specifically, the input accepting unit 11 inserts a data record into the request management data 902 as follows.

The value of the item “request ID” is the value assigned by the request management server 10 to be unique according to a predetermined rule.

The value of the item “requester user ID” is the user ID of the requester 2.

The value of the item “work name” is the text input input in the work name input field 1201.

The value of the item “completion due date” is the value input in the completion due date field 1202.

The value of the item “work content” is the value input in the work content input field 1203.

The value of the item “worker user ID” is the user ID of the worker input in the worker input field 1204.

The value of the item “progress status” is “work in progress”. Note that an example is given where “work in progress” is the value, because a work request report mail is transmitted through a series of processes. However, when the request management server 10 executes the process of transmitting the work request report mail by batch processing or the like, the value of the item “progress status” of the data record inserted herein may be, for example, “accepted”. In this case, the request management server 10 updates the value of the item “progress status” to “work in progress” after the process of transmitting the work request report mail, which will be described later.

The value of the item “work completion date and time” is null here. The request management server 10 updates the value of the item “work completion date and time” by receiving the completion report information in the process to be described later.

In step S103, the work request transmitting unit 12 transmits the work request report mail to the mail server 20.

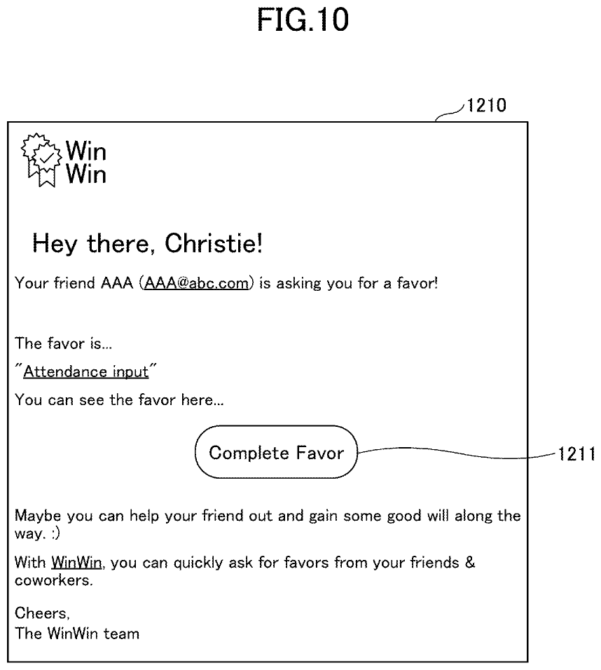

FIG. 10 is a diagram illustrating an example of a work request report mail according to the first embodiment.

A work request report mail 1210 is an e-mail reporting to the worker 3 to whom the work has been requested. The destination of the work request report mail is the e-mail address of the worker 3. The text of the work request report mail includes the work request information and the completion report information.

Specifically, for example, if the work request report mail is in an HTML format, the completion report information is included in a completion report button 1211. The completion report button 1211 is embedded with a link indicating a communication destination when the button is pressed.

For example, a first example of a link embedded in the completion report button 1211 is “https://(domain name)/task/complete/(worker user ID)/(work request ID)”.

A second example of a link embedded in the completion report button 1211 is “https://(domain name)/task/complete?userID=(worker user ID)&taskID=(work request ID)”.

In either example, the link includes an identifier (worker user ID) to identify the worker and an identifier (work request ID) to identify the work request. The domain name is a value indicating the Internet location of the request management server 10.

With this information, the request management server 10 can identify the work request and the worker of the completed work.

If the work request report mail is in text form, the text of the work request report mail includes a character string indicating the above-described link.

Returning to FIG. 8, when the operation accepting unit 32 of the terminal 30b accepts the mail reception operation of the worker 3, the communication unit 33 transmits a request for transmitting an e-mail addressed to the e-mail address of the worker 3, to the mail server 20. Therefore, in step S104, the mail server 20 transmits the work request report mail to the terminal 30b (step S104).

The worker 3 performs the requested work. For example, the worker 3 inputs attendance information (step S105). When the operation accepting unit 32 of the terminal 30b accepts the input operation, in step S106, the communication unit 33 transmits the input attendance information to the work server 40. In step S107, the work server 40 accepts the received attendance information and transmits a signal indicating that the registration of the attendance information is successful, to the terminal 30b.

Next, the worker 3 presses the completion report button 1211 (step S108). When the operation accepting unit 32 of the terminal 30b accepts the pressing operation, in step S109, the communication unit 33 transmits the completion report information to the request management server 10. The completion report information is information including the worker user ID and the work request ID.

When the work completion accepting unit 13 of the request management server 10 receives the completion report information, in step S110, the work completion accepting unit 13 updates the request management data stored in the storage unit 16. Specifically, the work completion accepting unit 13 identifies a data record of the request management data to be updated based on the worker user ID and the work request ID. Then, the value of the item “progress status” included in the identified data record is updated to “completed”, and the value of the item “work completion date and time” is updated to the date and time when the completion report information is received.

In step S111, the work completion reporting unit 15 transmits the work completion report mail to the mail server 20. A work completion report mail is an e-mail reporting to the requester 2 that the work has been completed. The destination of the work completion report mail is the e-mail address of the requester 2. Further, the text of the work completion report mail includes a link for displaying the work result confirmation screen.

When the operation accepting unit 32 of the terminal 30a accepts the mail reception operation by the requester 2, in step S112, the communication unit 33 receives an e-mail addressed to the e-mail address of the requester 2 from the mail server 20. Therefore, the mail server 20 transmits the work completion report mail to the terminal 30a.

In step S113, the requester 2 clicks (or taps a screen of a smartphone or the like) on the link included in the text of the work completion report mail, by using a pointing device such as a mouse. When the operation accepting unit 32 of the terminal 30a accepts the click operation, in step S114, the communication unit 33 transmits a display request signal for the work result confirmation screen to the request management server 10. The display request signal for the work result confirmation screen is a signal requesting the display of the work result confirmation screen, specifically, a HTTP request, or the like. The work result confirmation screen is a screen for displaying the results of the work by the worker 3.

In step S115, the display control unit 14 of the request management server 10 transmits the work result confirmation screen data to the terminal 30a. The work result confirmation screen data is screen data indicating the work result confirmation screen.

In the processing of step S115, the display control unit 14 confirms whether login of the requester 2 is authenticated as the user, and when login is not authenticated, screen data for login authentication may be transmitted. In this case, after the login authentication, the display control unit 14 transmits the work result confirmation screen data to the terminal 30a.

Further, the link included in the text of the work completion report mail, may be embedded with session information corresponding to a state where login has been authenticated, and the session information may be included in the display request signal for the work result confirmation screen. In this case, the display control unit 14 transmits the state in which login of the requester 2 is authenticated as a user and the work result confirmation screen data to the terminal 30a.

When the communication unit 33 of the terminal 30a receives the work result confirmation screen data, the display unit 31 displays the work result confirmation screen according to the received work result confirmation screen data (step S116).

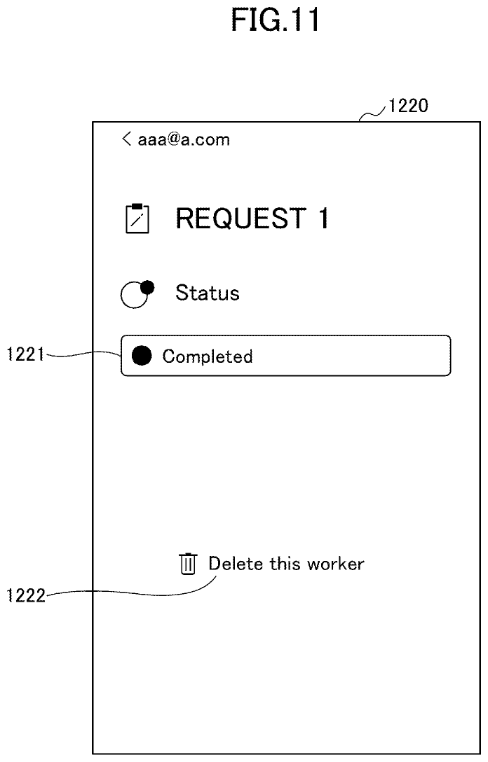

FIG. 11 is a diagram illustrating an example of a work result confirmation screen.

A work result confirmation screen 1220 includes a status display 1221 and a worker deletion button 1222.

The status display 1221 displays information indicating whether the work has been completed. In the status display 1221, the value of the item “progress status” included in the request management data 902, is applied.

Note that, in the example of FIG. 11, the value of the item “progress status” included in the request management data 902 is “completed”, and, therefore, information indicating that the work has been completed is displayed.

The worker deletion button 1222 is a GUI for accepting an operation to delete the corresponding worker's data record from the request management data 902 with respect to the corresponding work.

When the operation accepting unit 32 of the terminal 30a accepts the pressing operation of the worker deletion button 1222, the communication unit 33 of the terminal 30a transmits a signal requesting to delete the data of the worker with respect to the corresponding work, to the request management server 10. When the signal is received, the request management server 10 deletes the corresponding data record of the request management data 902 from the storage unit 16.

According to the request management system 1 according to the present embodiment, the request management server 10 transmits the completion report information in association with the work request information, to the mail server 20, with the destination being the terminal 30b operated by the worker 3. “In association with” means that the work request information and the completion report information are transmitted in such a way that the work request information and the completion report information can both be displayed simultaneously, can both be displayed within one page, and in such a way that when one is displayed, the other also is displayed, and the like. This allows the worker 3 to report the completion of the work by the operation of transmitting the received completion report information.

In a case where it is assumed that the completion report information is not transmitted, even if communication to the request management server 10 is not a required task, the worker 3 is required to transmit, to the request management server 10, a display request for a screen for reporting the completion of the work by operating the terminal 30b, and to perform an input operation to the displayed screen. On the other hand, the request management system 1 according to the present embodiment does not require the user to perform such an input operation, and, therefore, the task of reporting the completion of work by the worker 3 can be facilitated.

In the present embodiment, the work request information and the completion report information are included in the text of the e-mail. Accordingly, the worker 3 can perform an operation of transmitting the completion report, as an extension of the operation of viewing the e-mail addressed to his/her own e-mail address without intentionally performing a communication operation to the request management server 10. However, the method in which the work request information and the completion report information are included in the text of the e-mail and are transmitted to the terminal 30b via the mail server 20, is one example, and other methods may be performed.

For example, the request management server 10 may transmit the work request information and the completion report information directly to the terminal 30b by a short message or via other devices. The request management server 10 may transmit information including a URI indicating a display screen of the work request information and the completion report information, to the terminal 30b, by a short message, an e-mail, or the like. In this case, when the terminal 30b communicates to the URI included in the transmitted information, in response to this communication, the request management server 10 transmits the work request information and the completion report information to the terminal 30b.

### (Second Embodiment)

A second embodiment will be described below with reference to the drawings. The second embodiment differs from the first embodiment in that the work request information and the completion report information are transmitted to the terminal via the schedule management server. Accordingly, in the description of the following second embodiment, the differences from the first embodiment are mainly explained, and elements having a functional configuration similar to those of the first embodiment are denoted by the same reference numerals as those used in the description of the first embodiment, and the descriptions thereof are omitted.

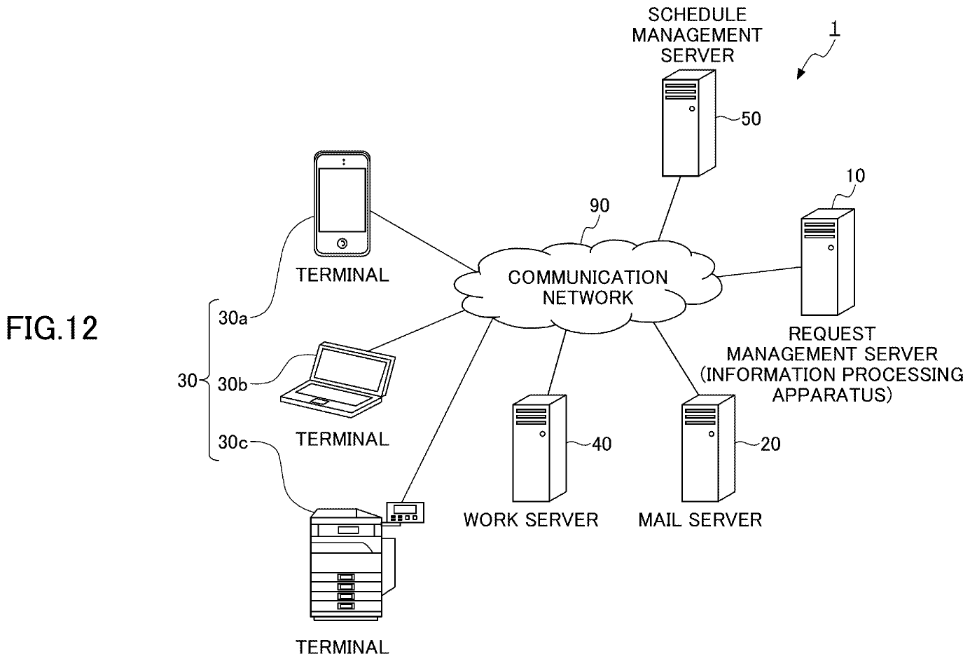

FIG. 12 is a diagram illustrating an example of a system configuration of a request management system according to the second embodiment.

The request management system 1 according to the present embodiment has a configuration in which a schedule management server 50 is added to the request management system 1 according to the first embodiment.

The schedule management server 50 is a schedule management apparatus having a function for managing the schedule of a worker. The schedule managed by the schedule management server 50 may include only the work requested by the request management system 1 or may also include other schedules.

The work request transmitting unit 12 of the request management server 10 according to the present embodiment transmits the work request information and the completion report information to the schedule management server 50 as a worker's schedule. The format for transmitting the information as a schedule is defined as an API, for example, by an application program or the like stored in the schedule management server 50. Therefore, the work request transmitting unit 12 transmits the work request information and the completion report information by the communication method of a predefined format.

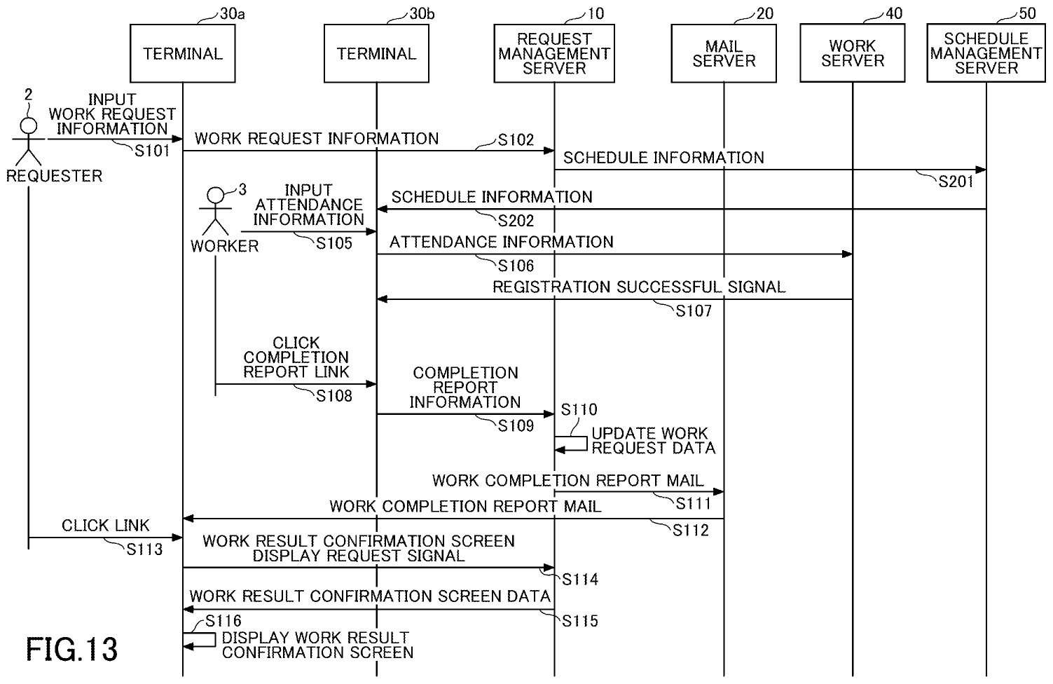

FIG. 13 is a diagram illustrating an example of a sequence of work request processing according to a second embodiment.

The work request processing according to the present embodiment differs from the work request processing according to the first embodiment in that step S103 and step S104 are substituted by step S201 and step S202.

In step S201, the work request transmitting unit 12 of the request management server 10 transmits the schedule information to the schedule management server 50. The schedule information includes work request information and completion report information and is information defined in advance in a format to be registered as a schedule of the worker 3.

The schedule management server 50 stores the received schedule information as the schedule of the worker 3.

When the operation accepting unit 32 of the terminal 30b accepts an operation for browsing the schedule by the worker 3, the communication unit 33 transmits a request to transmit the information indicating the schedule of the worker 3, to the schedule management server 50. Thus, in step S202, the schedule management server 50 transmits the schedule information transmitted in step S201 to the terminal 30b.

When the communication unit 33 of the terminal 30b receives the schedule information, the display unit 31 displays the schedule display screen.

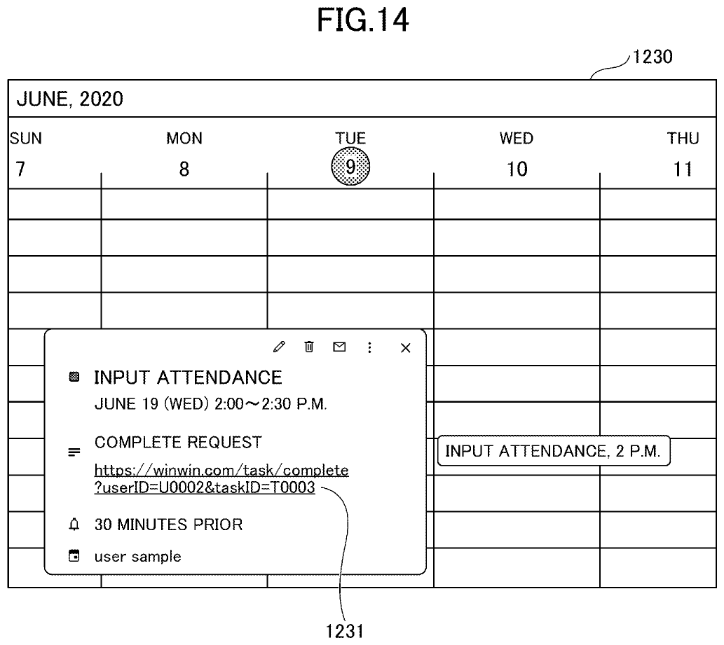

FIG. 14 is a diagram illustrating an example of a schedule display screen according to the second embodiment.

A schedule display screen 1230 includes work request information and completion report information as a schedule of the worker 3. The completion report information is displayed, for example, as a completion report link 1231. Similar to the completion report button 1211 according to the first embodiment, the completion report link 1231 includes an identifier (worker user ID) for identifying the worker and an identifier (work request ID) for identifying the work request.

Then, similar to the first embodiment, when the work is completed, the worker 3 clicks the completion report link 1231 (step S108). When the operation accepting unit 32 of the terminal 30b accepts the click operation, in step S109, the communication unit 33 transmits the completion report information to the request management server 10, similarly to the first embodiment. The subsequent processing is similar to the first embodiment.

According to the request management system 1 according to the present embodiment, the request management server 10 transmits the completion report information in association with the work request information to the schedule management server 50, with the terminal 30b being the destination. This allows the worker 3 to report the completion of the work by the operation of transmitting the received completion report information.

In the present embodiment, the work request information and the completion report information are stored in the schedule management server 50 as a schedule of the worker 3. Accordingly, the worker 3 can perform an operation of transmitting a completion report as the extension of the operation of viewing his or her own schedule, without intentionally performing a communication operation to the request management server 10.

### (Third Embodiment)

A third embodiment will now be described with reference to the drawings. The third embodiment differs from the first embodiment in that the requester selects a method for completing the work. Accordingly, in the description of the third embodiment below, the differences from the first embodiment are mainly explained, and elements having a functional configuration similar to those of the first embodiment are denoted by the same reference numerals as those used in the description of the first embodiment, and the descriptions thereof are omitted.

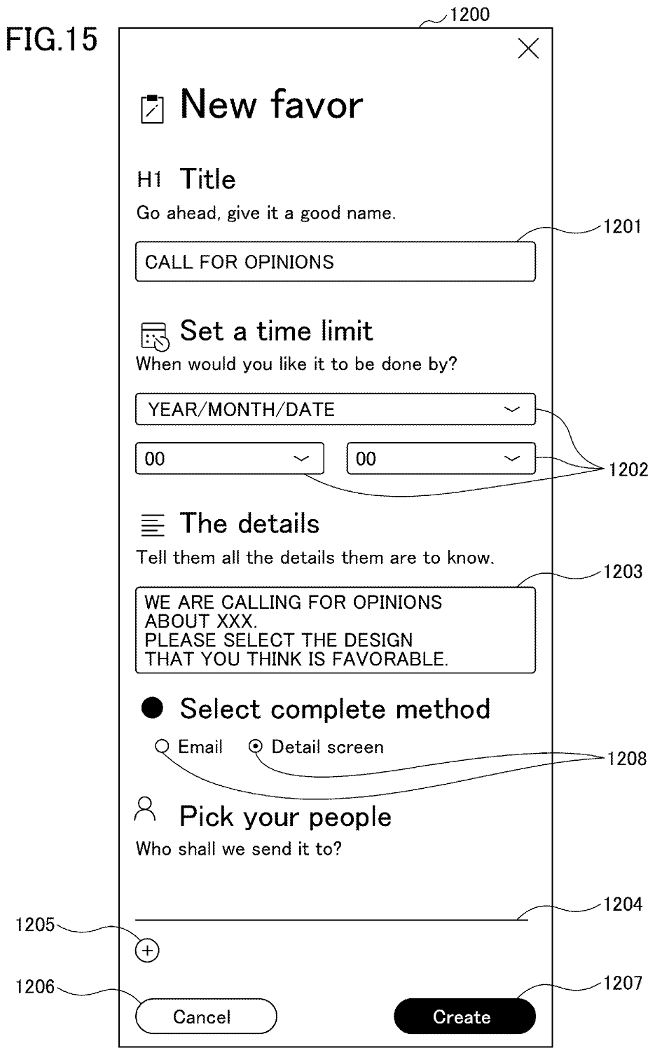

FIG. 15 is a diagram illustrating an example of a work request input screen according to the third embodiment.

The work request input screen 1200 according to the present embodiment further includes a selection field 1208 for selecting a work completion method, in addition to the work request input screen 1200 according to the first embodiment.

The selection field 1208 includes, as options of the work completion method, a method for transmitting a completion report from a report mail including the work request information and the completion report information, as in the example illustrated in the first embodiment, and a method for transmitting a completion report from a work detail screen. The options of the work completion method may include other methods. For example, options of the work completion method may include a method of transmitting a completion report from a schedule managed by the schedule management server 50, as described in the second embodiment.

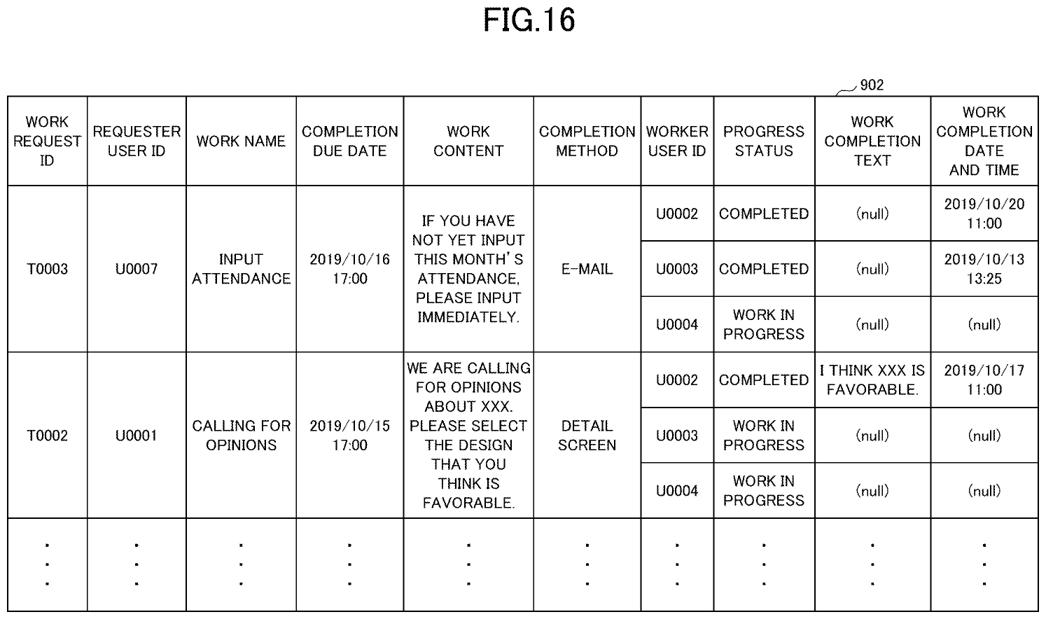

FIG. 16 is a diagram illustrating an example of request management data according to the third embodiment.

The request management data 902 according to the present embodiment further includes the items of a completion method and work completion text, in addition to the request management data 902 according to the first embodiment.

The value of the item “completion method” indicates the selected completion method. The item “completion method” is an item that has a value for each work request.

The value of the item “work completion text” is a text indicating a work completion report, an answer to a question, a comment with respect to the call for opinions, and the like. The item “work completion text” is an item having a value for each worker performing the work.

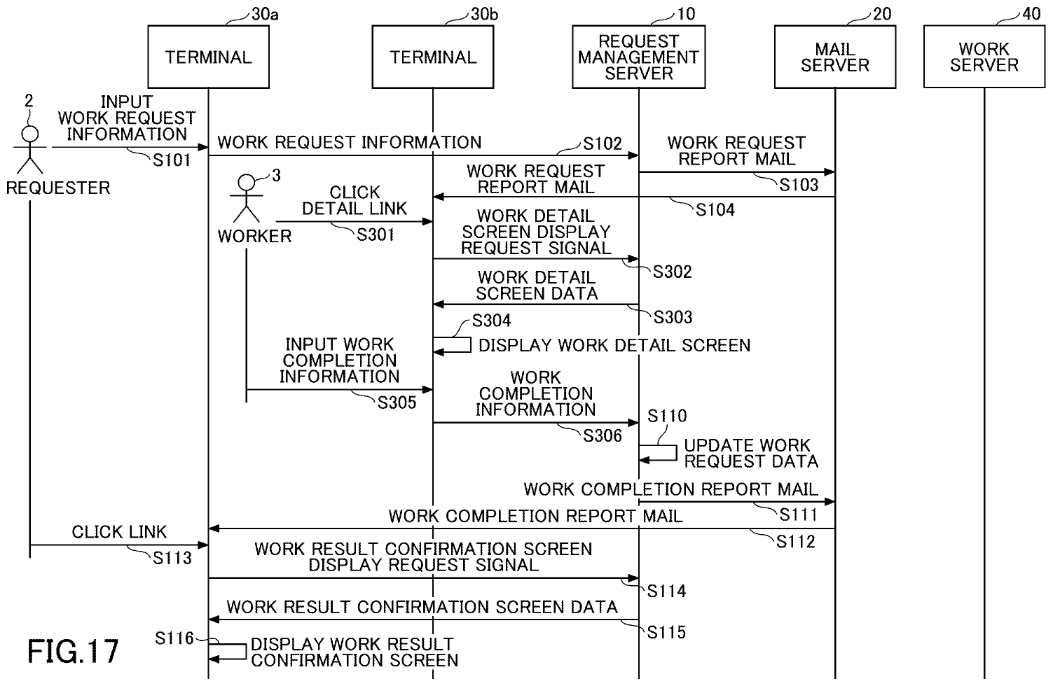

FIG. 17 is a diagram illustrating an example of a sequence of work request processing according to the third embodiment.

The work request process illustrated in FIG. 17 is an example in which the value of the item “completion method” included in the request management data 902 is the “detail screen”. When the value of the item “completion method” is “mail”, the process is the same as that of the work request process according to the first embodiment. The value of the item “completion method” may also include an option to perform a work request process according to the second embodiment.

When the value of the item “completion method” included in the request management data 902 is the “detail screen”, the work request report mail in step S103 of the work request process according to the first embodiment includes a detail link for displaying the work detail screen, instead of including the completion report information.

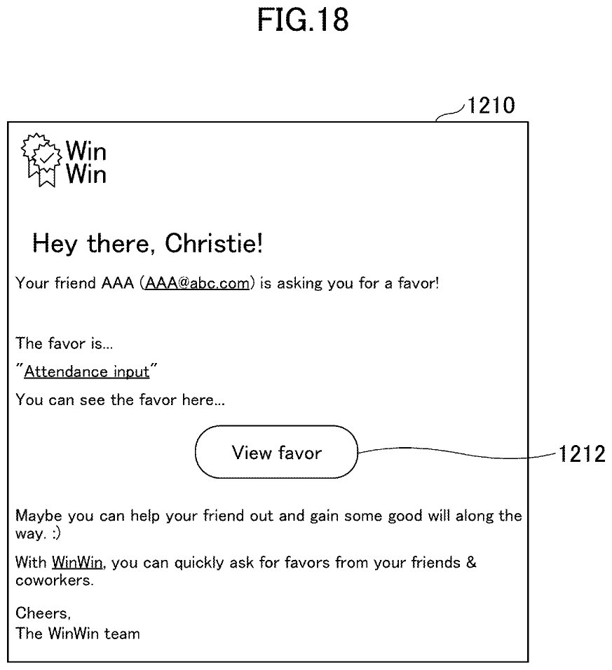

FIG. 18 is a diagram illustrating an example of a work request report mail according to the third embodiment.

The work request report mail 1210 according to the present embodiment includes a detail link 1212 instead of the completion report button 1211 according to the first embodiment. The detail link 1212 includes, for example, a URI or the like for displaying a work detail screen.

Returning to FIG. 17, the worker 3 clicks the detail link 1212 (step S301). When the operation accepting unit 32 of the terminal 30b accepts the click operation, in step S302, the communication unit 33 transmits a signal to request the display of the work detail screen to the request management server 10. The signal to request the display of the work detail screen is a signal requesting the display of the work detail screen, specifically, an HTTP request, or the like. The work detail screen displays the content of the work requested by the requester 2.

Next, in step S303, the display control unit 14 of the request management server 10 transmits the work detail screen data to the terminal 30b. The work detail screen data is screen data indicating the work detail screen.

In the process of step S303, the display control unit 14 confirms whether login of the worker 3 is authenticated as the user, and when login is not authenticated, screen data for login authentication may be transmitted. In this case, after the login authentication, the display control unit 14 transmits the work detail screen data to the terminal 30b.

Further, the detail link 1212 may be embedded with session information corresponding to a state where login has been authenticated, and the session information may be included in the display request signal for the work detail screen. In this case, the display control unit 14 transmits the state in which login of the worker 3 is authenticated as a user and the work detail screen data to the terminal 30b.

When the communication unit 33 of the terminal 30b receives the work detail screen data, the display unit 31 displays the work detail screen according to the received work detail screen data (step S304).

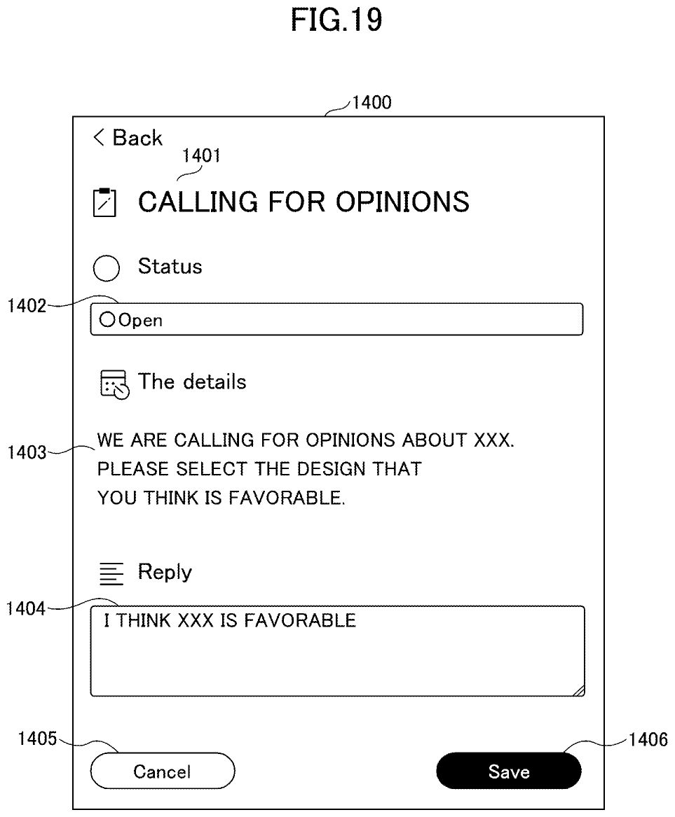

FIG. 19 is a diagram illustrating an example of a work detail screen according to the third embodiment.

A work detail screen 1400 includes a work name display 1401, a status display 1402, a work content display 1403, a work completion text input field 1404, a cancel button 1405, and a registration button 1406.

The work name display 1401 is a text indicating the work name. In the work name display 1401, the value of the item “work name” included in the request management data 902, is applied.

The status display 1402 displays whether the work has been completed. In the status display 1402, the value of the item “progress status” included in the request management data 902, is applied.

The work content display 1403 is a text indicating the work content input by the requester 2. In the work content display 1403, the value of the item “work content” included in the request management data 902, is applied.

The work completion text input field 1404 is a text area for accepting input of the work completion text by the worker 3.

The cancel button 1405 is a GUI for cancelling the input of work completion text.

The registration button 1406 is a GUI for registering the input information.

Returning to FIG. 17, the worker 3 inputs the work completion information to the terminal 30b (step S305). Specifically, when the worker 3 performs an input operation according to the work detail screen displayed on the terminal 30b, the operation accepting unit 32 of the terminal 30b accepts the input of the work completion information.

In step S306, the communication unit 33 of the terminal 30b transmits the work completion information to the request management server 10. When the work completion information is received, in step S110, similarly to the first embodiment, the work completion accepting unit 13 of the request management server 10 updates the request management data stored in the storage unit 16. The subsequent processing is similar to that of the first embodiment.

According to the request management system 1 according to the present embodiment, the method of completing a plurality of pieces of work is implemented according to the selection by the requester 2. This allows requester 2 to flexibly select a suitable completion method depending on the content, type, characteristics, or the like, of the work. For example, if the work content is not related to the request management server 10, such as the attendance input, the requester 2 may select a method for transmitting a completion report from the work request report mail. Further, if the work content is to input work completion text to the request management server 10, as in the case of calling for opinions, the requester 2 may select a method for displaying the work detail screen.

The group of apparatuses described in each embodiment represents only one of a plurality of computing environments for carrying out the embodiments disclosed herein.

In some embodiments, the request management server 10 includes a plurality of computing devices, such as a server cluster. The plurality of computing devices are configured to communicate with each other via any type of communication link, including networks, a shared memory, and the like, and may perform the processes disclosed herein.

The functions of each of the embodiments described above may be implemented by one or more processing circuits. As used herein, a “processing circuit” includes a processor programmed to execute each function by software such as a processor implemented in an electronic circuit; or devices such as an Application Specific Integrated Circuit (ASIC) a digital signal processor (DSP), a field programmable gate array (FPGA), and a conventional circuit module, designed to execute each function as described above.

The request management server 10, the mail server 20, the terminal 30, the work server 40, or the schedule management server 50 according to the above-described embodiment may be, for example, an output device such as a projector (PJ) and a digital signage, a remote conference apparatus, a Head Up Display (HUD) device, an industrial machine, a medical device, a network appliance, a connected car, a notebook PC, a mobile phone, a tablet terminal, a game machine, a Personal Digital Assistant (PDA), a digital camera, an entire celestial sphere panoramic image capturing device, a wearable PC, a desktop PC, and the like.

According to one embodiment of the present invention, the reporting of the completion of work by a worker can be facilitated.

The information processing apparatus, the request management method, and the recording medium are not limited to the specific embodiments described in the detailed description, and variations and modifications may be made without departing from the spirit and scope of the present invention.

What is claimed is:

1. An information processing apparatus comprising:
circuitry; and
a memory storing computer-executable instructions that cause the circuitry to execute:
transmitting, to a terminal operated by a worker, completion report information used for reporting completion of work that is requested, in association with work request information relating to a request for the work; and
updating a value of a progress status of the work identified by the completion report information, in request management data by which the progress status is managed, to a value indicating completion of the work, in response to receiving the completion report information from the terminal.

2. The information processing apparatus according to claim 1, wherein the transmitting includes transmitting an e-mail including the work request information and the completion report information, to an e-mail address of the worker.

3. The information processing apparatus according to claim 1, wherein the transmitting includes transmitting the work request information and the completion report information as a schedule of the worker, to a schedule management apparatus having a function of managing the schedule of the worker.

4. The information processing apparatus according to claim 1, wherein
the completion report information includes a Uniform Resource Identifier (URI) including an identifier for identifying the worker and an identifier for identifying the request for the work, and wherein
the updating includes updating the value of the progress status according to communication to a communication destination indicated by the URI.

5. The information processing apparatus according to claim 1, wherein the circuitry is further caused to execute:
transmitting, to an e-mail address of a requester of the work, an e-mail indicating the completion of the work, in response to receiving the completion report information.

6. The information processing apparatus according to claim 1, wherein the transmitting includes either transmitting, to the terminal, the work request information together with the completion report information, or transmitting, to the terminal, the work request information together with information for requesting information indicating a detail of the work, according to a selection made by a requester of the work.

7. A request management method executed by an information processing apparatus, the request management method comprising:
transmitting, to a terminal operated by a worker, completion report information used for reporting completion of work that is requested, in association with work request information relating to a request for the work; and
updating a value of a progress status of the work identified by the completion report information, in request management data by which the progress status is managed, to a value indicating completion of the work, in response to receiving the completion report information from the terminal.

8. A non-transitory computer-readable recording medium storing a program that causes a computer to execute a process, the process comprising:
transmitting, to a terminal operated by a worker, completion report information used for reporting completion of work that is requested, in association with work request information relating to a request for the work; and
updating a value of a progress status of the work identified by the completion report information, in request management data by which the progress status is managed, to a value indicating completion of the work, in response to receiving the completion report information from the terminal.
